(19) United States
(12) Patent Application Publication
(10) Pub. No.: US 2010/0037751 A1
(43) Pub. Date: Feb. 18, 2010

(54) BINDING FOR MUSICAL INSTRUMENTS

(76) Inventor: Jong Hoon Kim, Seoul (KR)

Correspondence Address: KANG INTELLECTUAL PROPERTY LAW, LLC, 214 ELM STREET, SUITE 106, WASHINGTON, MO, 63090, US

(21) Appl. No.: 12/365,656

(22) Filed: Feb. 4, 2009

(30) Foreign Application Priority Data
Aug. 12, 2008 (KR) 20-2008-0010745

(51) Int. Cl. G10D 3/00; B32B 5/00

(52) U.S. Cl. 84/453; 428/156

(57) ABSTRACT

Disclosed herein is a binding for musical instruments. The binding comprises a combination of a base and a decoration strip. The base is formed with a groove having a sinuate shape. The decoration strip is formed of a plurality of thin and elongated materials having different colors. The thin and elongated materials are attached to each other into a single body. Thus, the musical instruments can be manufactured so as to have more beautiful appearances, and provide more active and meaningful feelings.

### CROSS-REFERENCE TO RELATED APPLICATIONS

This application claims priority to Korean Patent Application No. 20-2008-0010745, filed on Aug. 12, 2008.

### BACKGROUND OF THE INVENTION

1. Field of the Invention

The present invention relates to a binding for musical instruments, and in more particular, to a binding for musical instruments which can insert a variety of colors, patterns or characters.

2. Background of the Related Art

Edges or corners of musical instruments such as guitar or violin are finished with a binding.

At present, a binding for musical instruments is mostly formed of celluloid or synthetic resin materials having a single color such as white, ivory, black and tortoise. Such a binding is cut into a desired size and attached to musical instruments. Thus, this binding appears monotonous and does not provide active feelings.

### SUMMARY OF THE INVENTION

Accordingly, the present invention has been made in view of the above-mentioned problems occurring in the prior art, and it is a primary object of the present invention to provide a binding for musical instruments which can insert a variety of colors, patterns or characters.

To accomplish the above object of the present invention, according to one aspect of the present invention, there is provided a binding for musical instruments. The binding comprises a combination of a base and a decoration strip.

In an embodiment, the base is formed with a groove having a sinuate shape.

In an embodiment, the decoration strip is formed of a plurality of thin and elongated materials having different colors. The thin and elongated materials are attached to each other into a single body.

In an embodiment, the decoration strip is formed of a single elongated material having a pattern or character formed thereon.

According to another aspect of the invention, there is provided a musical instrument of which edge or corner is finished with the above binding for musical instruments.

As described above, the binding for musical instruments of the invention comprises a combination of a base and a decoration strip. The decoration strip inserted into the base has a variety of colors, patterns or characters, thereby enabling to manufacture musical instruments having more active and beautiful appearances and providing meaningful feelings.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a guitar finished with a binding S according to an embodiment of the present invention;

FIG. 2 is an enlarged view for the portion ‘A’ in FIG. 1;

FIG. 3a is a perspective view showing a base of the binding according to an embodiment of the present invention;

FIG. 3b is a perspective view showing a decoration strip of the binding according to an embodiment of the present invention;

FIG. 3c is a perspective view showing a combination of the base and decoration strip according to an embodiment of the present invention;

FIG. 4 shows an embodiment of a binding combined with a decoration strip having patterns or characters, according to an embodiment of the present invention.

### DETAILED DESCRIPTION OF THE PREFERRED EMBODIMENT

Hereinafter, exemplary embodiment according to the present invention will be described in detail with reference to the appended drawings.

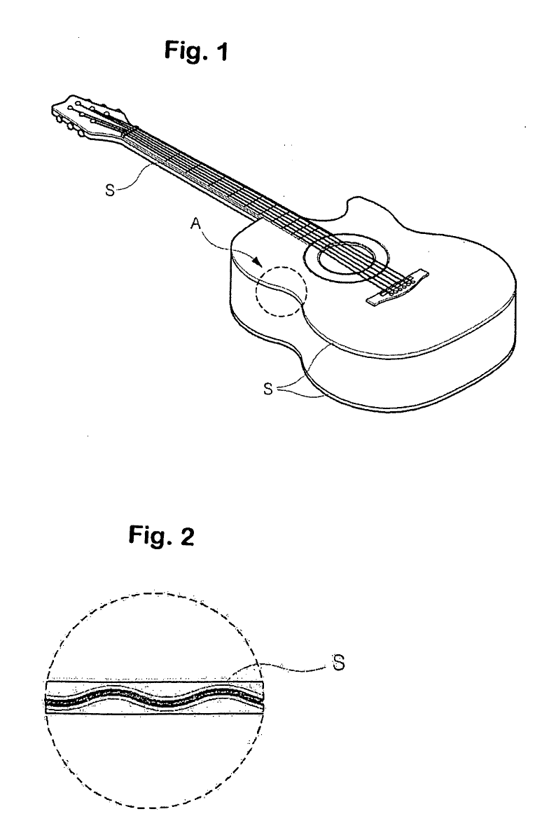

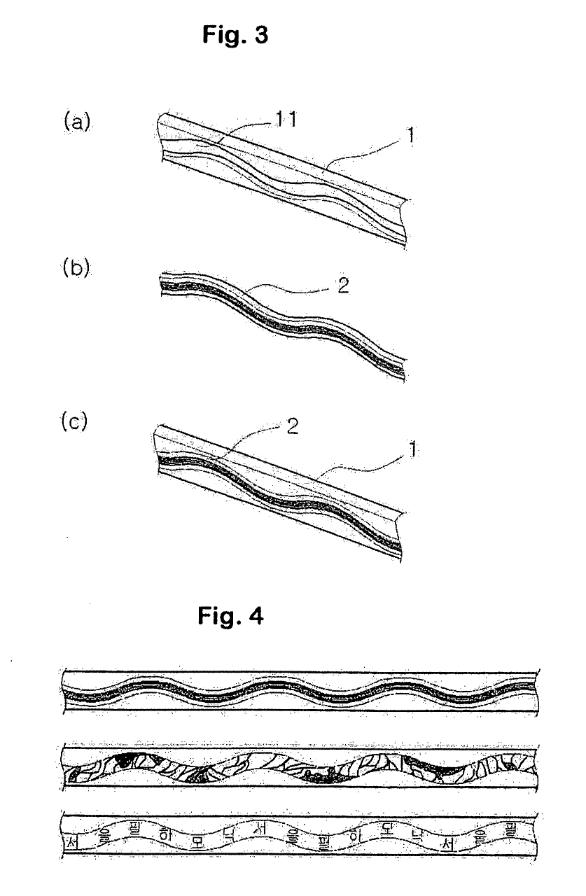

FIG. 1 is a perspective view showing a guitar finished with a binding S according to an embodiment of the present invention. FIG. 2 is an enlarged view for the portion ‘A’ in FIG. 1. FIG. 3a is a perspective view showing a base 1 of the binding S according to an embodiment of the invention. FIG. 3b is a perspective view showing a decoration strip 2 of the binding S according to an embodiment of the invention. FIG. 3c is a perspective view showing a combination of the base 1 and decoration strip 2 according to an embodiment of the invention. FIG. 4 shows an embodiment of a binding S combined with a decoration strip 2 having patterns or characters, according to an embodiment of the invention.

As illustrated in FIG. 3, a binding S for musical instruments according to an embodiment of the invention comprises a base 1 and a decoration strip 2. The base 1 is formed in the shape of a strip using ABS resin or the like. The base 1 includes a groove 11 formed in the lengthwise direction. The decoration strip 2 is inserted into the groove 11. It is preferable that the groove 11 formed in the base 1 has a sinuate form, but not limited thereto.

The decoration strip 2 may be formed by attaching a plurality of thin and elongated materials to each other into a singly body. The thin and elongated materials may have different colors. Alternatively, the decoration strip 2 may be formed of a single wide and elongated material, on the surface of which patterns or characters are formed. It is preferably that the patterns formed in the decoration strip 2 are good-looking and active, and the characters thereof are meaningful phrases or sentences such as names of persons or organization, mottos, slogan or the like

Further, particular patterns or characters may be continuously formed, or different patterns or characters may be continuously disposed. In addition, the patterns or characters may have a simple form or shape, or may have a combination of various color and patterns. Preferably, such a decoration strip 2 be formed of a synthetic resin, but not limited thereto. For example, other materials such as an iron plate can be used for the decoration strip 2.

A favorite decoration strip 2 is inserted into the groove 11 formed in the base 1 to thereby complete a binding S according to the present invention. The finished binding S can be used to finish edges or corners of musical instruments. Here, the decoration strip 2, which is inserted into the groove 11 of the base 1, may be completely adhered to the base 1. Alternatively, the decoration strip 2 may be detachably attached to the base 1, thereby enabling to be replaced with other one having different patterns or characters, when necessary.

As described above, the binding S for musical instruments of the invention comprises a combination of a base 1 and a decoration strip 2. The decoration strip 2 inserted into the base 1 has a variety of colors, patterns or characters, thereby enabling to manufacture musical instruments having more active and beautiful appearances and providing meaningful feelings.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A binding for musical instruments, the binding comprising a combination of an elongated base and a decoration strip;
wherein said base has a groove for receiving said decoration strip; and
wherein said decoration strip is received in said groove.

2. The binding according to claim 1, wherein said groove comprises a sinuate groove.

3. The binding according to claim 1, wherein the decoration strip is formed of a plurality of thin and elongated materials having different colors, the thin and elongated materials being attached to each other into a single body.

4. The binding according to claim 1, wherein the decoration strip is formed of a single elongated material having a pattern or character formed thereon.

5. A musical instrument comprising:
edge or corner finished with a binding, the binding comprising a combination of an elongated base and a decoration strip;
wherein said base has a groove for receiving said decoration strip; and
wherein said decoration strip is received in said groove.

6. The musical instrument according to claim 5, wherein said groove comprises a sinuate groove.

7. The musical instrument according to claim 5, wherein the decoration strip is formed of a plurality of thin and elongated materials having different colors, the thin and elongated materials being attached to each other into a single body.

8. The musical instrument according to claim 5, wherein the decoration strip is formed of a single elongated material having a pattern or character formed thereon.
